(19) United States
(12) Patent Application Publication
(10) Pub. No.: US 2004/0255516 A1
(43) Pub. Date: Dec. 23, 2004

(54) Cable tensioner

(76) Inventors: Fabien Dufour, Chateauneuf Sur Loire (FR); Marcel Leveille, Sully Sur Loire (FR)

Correspondence Address: CARLSON, GASKEY & OLDS, P.C., 400 WEST MAPLE ROAD, SUITE 350, BIRMINGHAM, MI, 48009, US

(21) Appl. No.: 10/870,670

(22) Filed: Jun. 17, 2004

(30) Foreign Application Priority Data
Jun. 20, 2003 (FR) 03 07 492

(51) Int. Cl. E05F 11/48

(52) U.S. Cl. 49/352

(57) ABSTRACT

A tensioner for a cable includes a fixing point and a free end. A first active part defines a first surface of the tensioner, and a second active part defines a second surface of the tensioner which is different from the first surface. The tensioner tensions the cable while following the displacement of the cable. One of the active parts acts as a tensioner on the cable, and the other of the active parts allows the free end of the cable tensioner to follow displacement of the cable, preventing the twisting of the tensioner or deformation of the cable. The tensioner can be employed with cable-driven window regulator for a vehicle.

### REFERENCE TO RELATED APPLICATIONS

This application claims priority to French Patent Application FR 03 07 492 filed on Jun. 20, 2003.

### TECHNICAL FIELD

The present invention relates to a vehicle cable-driven window regulator, and more specifically to a tensioner employed with a window regulator cable.

### BACKGROUND OF THE INVENTION

U.S. Pat. No. 4,235,046 discloses a cable tensioner in the form of a leaf spring that is fixed onto a plate. A cable passes into a holding system fixed onto a free end of the tensioner, and the tensioner then exerts a force on the cable in a plane parallel to the plane of the plate. The tensioner is used for cables that have a small angular displacement in a plane perpendicular to the plate, for example, for a cable extending between two pulleys.

By contrast, for a cable that extends between a pulley and a driving drum, the winding of the cable on the drum moves the cable from one end of the drum to the other. This movement can reach 15 cm, creating a large angular displacement of the cable in the vicinity of the drum. The tensioner disclosed in U.S. Pat. No. 4,235,046 cannot correctly ensure the tension of the cable in the vicinity of the drum. If the tensioner is not sufficiently rigid, the force exerted by the cable on the tensioner is in the plane defined by the angular displacement, and the tensioner is then at risk of being twisted and damaged. If the tensioner is sufficiently rigid, the tensioner will not deform, but the cable will not remain straight and will suffer deformation near the cable holding system which may cause excessive wear and breakage of the cable.

There is therefore a need for a cable tensioner that can follow angular displacements of a cable perpendicular to the direction of the tensional forces in the cable without being damaged and without damaging the cable.

### SUMMARY OF THE INVENTION

The present invention provides a cable tensioner including a fixing point and a free end. A first active part defines a first surface and a second active part defines a second surface that is different from the first surface. The first active part and the second active part are located between the fixing point and the free end of the cable tensioner.

According to one embodiment, the second surface is substantially perpendicular to the first surface. Preferably, the first surface is flat and the second surface is substantially cylindrical.

According to another embodiment, the tensioner also includes an intermediate part between the first active part and the second active part. The intermediate part is preferably twisted a quarter-turn.

According to one embodiment, the tensioner is a leaf spring. According to another embodiment, the free end of the tensioner is equipped with a cable holding system.

The invention also provides a window regulator including a cable tensioner according to one of the preceding embodiments and a cable that preferably cooperates with the free end of the tensioner.

The window regulator can further include a cable direction-changing system, and the fixing point of the tensioner is preferably situated opposite the cable direction-changing system.

Other characteristics and advantages of the invention will become apparent from reading the following detailed description of the embodiments of the invention, given by way of example only, and with reference to the drawings.

### BRIEF DESCRIPTION OF THE DRAWINGS

FIG. 1 schematically illustrates a view of a cable tensioner according to the present invention;

FIG. 2 schematically illustrates a top view of the cable tensioner showing the tensioning of the cable;

FIG. 3 schematically illustrates a side view of the cable tensioner showing the cable during the angular displacement; and

FIG. 4 schematically illustrates a view of a window regulator using the cable tensioner according to the present invention.

### DETAILED DESCRIPTION OF PREFERRED EMBODIMENTS

The invention provides a cable tensioner extending between a fixing point and a free end. The tensioner includes a first active part defining a first surface and a second active part defining a second surface different from the first surface. The two surfaces are located between the fixing point and the free end. The two active parts act in different directions. One part acts as a tensioner on the cable and the other part allows the free end of the tensioner to follow displacements of the cable, preventing the twisting of the tensioner or deformation of the cable.

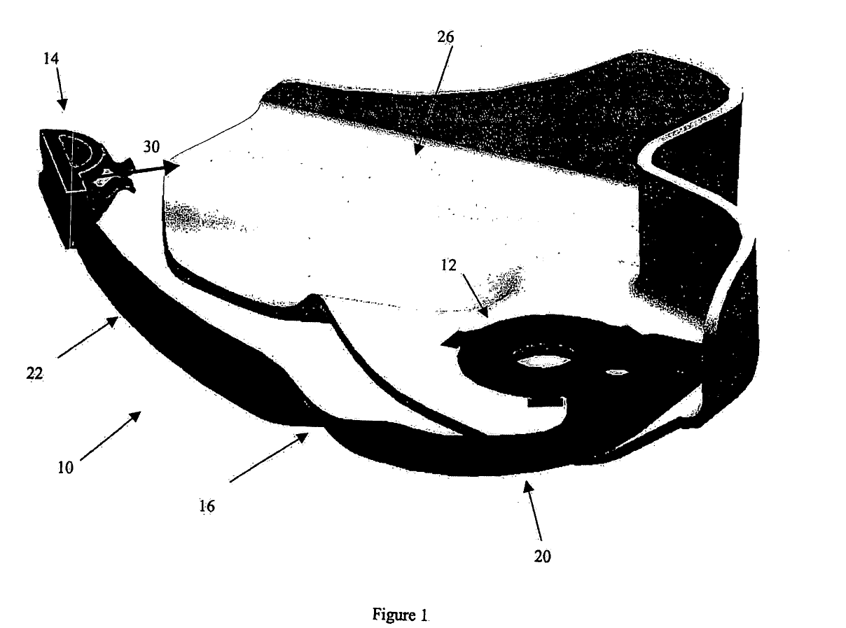

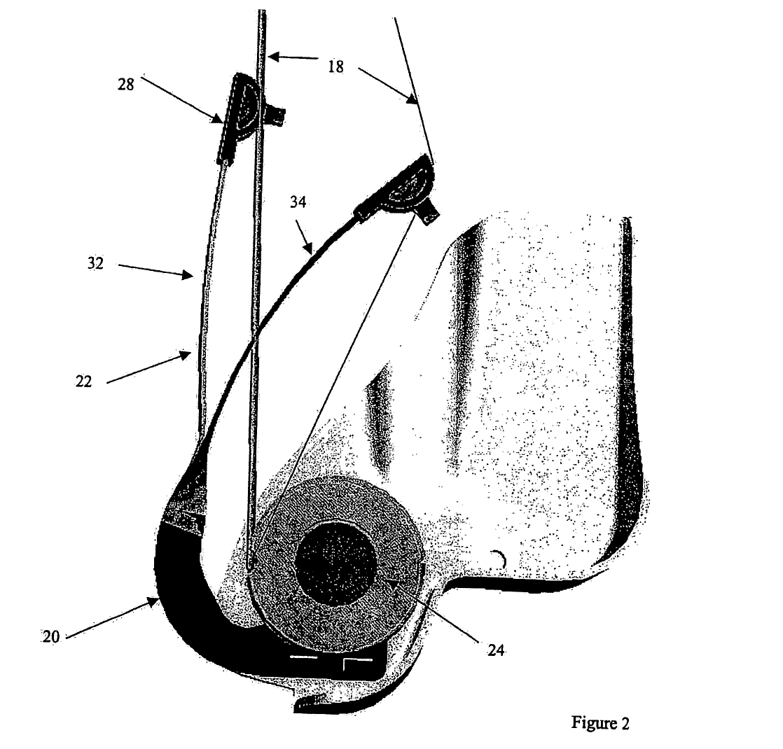

FIG. 1 represents a cable tensioner 10 of a cable 18 (shown in FIG. 2) including a fixing point 12 and a free end 14. The cable tensioner 10 includes a first active part 20 defining a first surface and a second active part 22 defining a second surface different from the first surface. The first active part 20 and the second active part 22 are located between the fixing point 12 and the free end 14.

The fixing point 12 is fixed to a fixed part 26 of the vehicle. The fixed part 26 can be a track for guiding a window regulator slide, a plate for fixing a window regulator motor, the frame of a door, or any other part of the vehicle. The fixing point 12 can be fixed to the fixed part 26 by welding, gluing, pins or by any other fixing system. One skilled in the art would know how to fix the fixing point 12 of the cable tensioner 10 to the fixed part 26. The window regulator includes, as known, a cable direction-changing system 24, such as pulleys or ramps. The cable tensioner 10 is preferably positioned at the same location of the cable direction-changing system 24, in particular, the fixing point 12 of the cable tensioner 10 is positioned opposite the cable direction-changing system 24, allowing the cable direction-changing system 24 and the cable tensioner 10 to be fixed in a single assembly operation. That is, the cable tensioner 10 is gripped between the cable direction-changing systems 24 and the fixed part 26. At least one pin (not shown) penetrates into the fixed part 26 of the cable tensioner 10 to prevent the cable tensioner 10 from rotating.

The free end 14 of the cable tensioner 10 can be equipped with a cable holding system 28 to hold the cable 18. The cable holding system 28 can be made of plastic and includde holding clips that prevent the cable 18 from disengaging from the cable holding system 28.

The first active part 20 is preferably close to the fixing point 12 and defines a flat surface. The fixing point 12 is generally made up of a flat part that extends to constitute the first active part 20 in order to facilitate the production of the cable tensioner 10 by minimizing the forming operations.

The second active part 22 is situated between the first active part 20 and the free end 14 and preferably defines a substantially cylindrical surface to tension the cable 18.

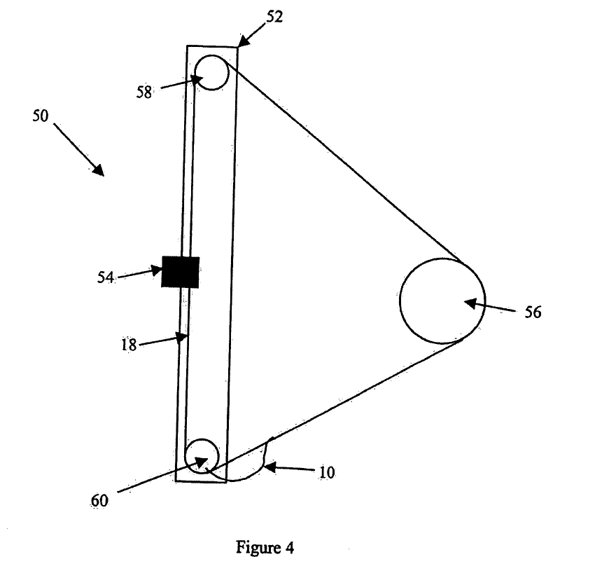

The two active surfaces 20 and 22 are defined as different surfaces to allow the cable tensioner 10 to act in two different directions. The cable 18 generally follows a substantially flat route (the plane of the page in FIG. 4), except at the location of the driving drum 56 (FIG. 4) where a displacement occurs in a plane perpendicular to the plane (plane vertical to the page in FIG. 4) parallel to the cable. The first active part 20 is perpendicular to the plane defined by the route of the cable 18, and the second active part 22 is parallel to the plane. Preferably, the two surfaces 20 and 22 are substantially perpendicular to allow the cable tensioner 10 to follow the cable 18 during its angular displacement.

The change in direction of the surface between the first active part 20 and the second active part 22 occurs through an intermediate part 16. Preferably, the intermediate part 16 is twisted a quarter of a turn. A change of direction of the cable 18 can thus be achieved simply and economically.

The cable tensioner 10 is preferably a leaf spring, but any material and structure having sufficient strength and flexibility characteristics can be employed.

The second active part 22 is near the free end 14 of the cable tensioner 10 and constantly holds the cable 18 under tension. This makes it possible to counter the wear of the different components of the window regulator, which can create slack in the cable 18. The second active part 22 exerts a force on the cable 18 (shown by the arrow 30) perpendicular to the surface at the point of the contact between the cable holding system 28 and the cable 18.

FIG. 2 represents the action of the cable tensioner 10 when the cable 18 is held under tension. When the window regulator is brand new, the components are not worn and the cable 18 is practically linear. The cable tensioner 10 is then situated in an initial position 32. When the window regulator and the components wear, the cable 18 must follow a longer path under the action of the cable tensioner 10, which is then situated in a tension position 34. The first active part 20 is near the fixing point 12 and meets the deflection requirements due to the forces generated by the angular displacement of the cable 18.

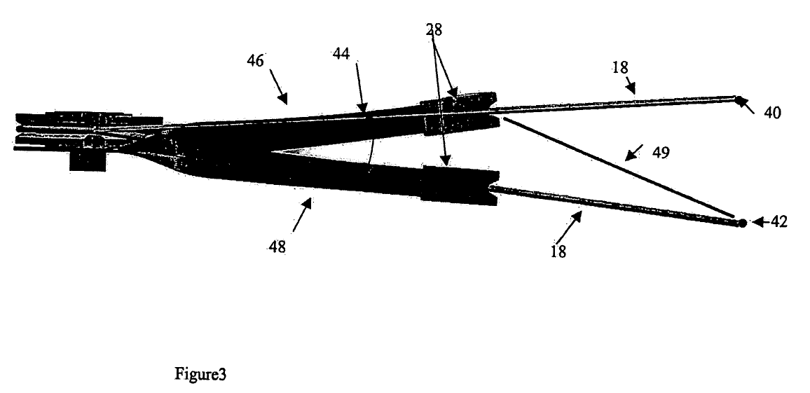

FIG. 3 represents the deflection function of the cable tensioner 10. The positions 40 and 42 represent, respectively, the upper and lower points where the cable 18 exits the driving drum 56. In the upper position 40, the cable 18 does not undergo any deviation and remains straight. In the lower position 42, the cable 18 undergoes an angular displacement 44.

If the cable tensioner 10 could not bend under the action of the angular displacement 44, the cable 18 would remain in the initial position 46, and the cable 18 would then take up an intermediate position 49 between the cable holding system 28 and the lower position 42 where the cable 18 exits the driving drum 56. The cable 18 would then be subjected to internal tensions due to successive bends at the location of the cable holding system 28.

In the present invention, the cable tensioner 10 can bend at the first active part 20. The cable tensioner 10 then moves to a second position 48, allowing the cable 18 and the cable tensioner 10 to remain co-linear, thus avoiding wear of the cable 18 or anarchic bending of the cable tensioner 10.

The cable tensioner 10 is preferentially dimensioned to be straight when the window is closed, as this is the most commonly used position in a vehicle. However, the cable tensioner 10 can be positioned so that its stable position is in the middle of the angle of displacement.

FIG. 4 shows an example of the use of the cable tensioner 10 according to the present invention in a window regulator 50 including the cable tensioner 10 and a cable 18. The window regulator 50 includes of a track 52 and a slide 54 fixed a window glass (not shown) slidable on the track 52. The driving drum 56, connected to a driving device, (for example a motor) drives the cable 18 fixed to the slide 54. The cable 18 passes through the cable direction-changing systems 58 and 60 fixed at the ends of the track 52, thus allowing the window glass to be raised and lowered.

The cable tensioner 10 according to the present invention is positioned, for example, at the location of the lower cable direction-changing system 60. The fixing point 12 of the cable tensioner 10 is then situated opposite to the cable direction-changing system 60.

The cable tensioner 10 could be located at the driving drum 56. Although the angular displacement is the same as the angular displacement at the location of the cable direction-changing system 60, the equivalent height is clearly greater.

Of course, the present invention is not limited to the examples and embodiments described and shown, but it is capable of numerous variants accessible to a person skilled in the art. The cable tensioner 10 of the present invention is produced in a single piece, but it can be produced with different materials if it is desirable to have different deflection properties for the two functions. The window regulator 50 is described as a one-track window regulator, but it can be transposed to a two-track window regulator or to a window regulator on a module or installed on doors. The respective positions of the first active part 20 and the second active part 22 can also be reversed relative to the fixing point 12.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A cable tensioner comprising:
a fixing point;
a free end;
a first active part located between the fixing point and the free end, the first active part defining a first surface; and
a second active part located between the fixing point and the free end, the second active part defining a second surface, and the second surface being different from the first surface.

2. The tensioner according to claim 1, wherein the second surface is substantially perpendicular to the first surface.

3. The tensioner according to claim 1, wherein the first surface is substantially flat.

4. The tensioner according to claim 1, wherein the second surface is substantially cylindrical.

5. The tensioner according to claim 1, further including an intermediate part between the first active part and the second active part.

6. The tensioner according to claim 5, wherein the intermediate part is twisted through a quarter-turn.

7. The tensioner according to claim 1, wherein the cable tensioner is a leaf spring.

8. The tensioner according to claim 1, further comprising a cable holding system, wherein the free end of the cable tensioner is equipped with the cable holding system.

9. The tensioner according to claim 1, wherein the fixing point is securable to a vehicle component.

10. A vehicle window regulator comprising:
a cable tensioner including a fixing point, a free end, a first active part located between the fixing point and the free end defining a first surface and a second active part located between the fixing point and the free end defining a second surface, the second surface being different from the first surface; and
a cable, and the cable tensioner adjusting a level of tension of the cable.

11. The window regulator according to claim 10, wherein the cable cooperates with the free end of the cable tensioner.

12. The window regulator according to claim 11, further comprising a cable direction-changing system, wherein the fixing point of the cable tensioner is located opposite to the cable direction-changing system.

13. The window regulator according to claim 10, further comprising a cable direction-changing system, wherein the fixing point of the cable tensioner is located opposite the cable direction-changing system.

14. The window regulator according to claim 10, wherein the fixing point is securable to a vehicle component.
